(19) United States
(12) Patent Application Publication
(10) Pub. No.: US 2005/0268019 A1
(43) Pub. Date: Dec. 1, 2005

(54) [INTERFACE AND SYSTEM FOR TRANSMITTING REAL-TIME DATA ]

(76) Inventors: Che-Hui Chang Chien, Taoyuan County (TW); Yung-Sheng Chao, Kaohsiung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/709,823

(22) Filed: Jun. 1, 2004

(51) Int. Cl. G06F 13/38

(52) U.S. Cl. 710/305

(57) ABSTRACT

A real-time data transmission interface suitable for transmitting a nonreal-time data in real-time and transmitting a real-time data in nonreal-time is provided. The present invention comprises a nonreal-time data interface unit for receiving/transmitting the nonreal-time data, and an I/O unit which is coupled to the nonreal-time data interface. In addition, the present invention further comprises a memory unit and a network interface control unit. Wherein, the memory unit is used to store the nonreal-time data and the real-time data. The network interface control unit is coupled to the memory unit for receiving/transmitting the real-time data.

### BACKGROUND OF INVENTION

1. Field of the Invention

The present invention relates to a real-time data transmission interface and a real-time data transmission system, and more particularly, to a real-time data transmission interface and a real-time data transmission system for transmitting a nonreal-time data in real-time and transmitting a real-time data in nonreal-time.

2. Description of the Related Art

A bus composed of a group of conductive wires and used as a communication path, is generally used to transmit data between component and system and between system and system. The conductive wires comprise address lines, data lines, and control lines, which are responsible to transmit the addresses, data, and control signals between component and system, and between system and system during each bus cycle according to the standard of the bus protocol, respectively.

There are various types of bus in market now, wherein the ANC bus is a military specification high speed/real-time bus, its data transmission rate is up to 4 MHz, and it mainly uses 16 bit in parallel for its data transmission. The ANC bus is mainly used to connect a real-time signal processing apparatus, such as a radar system, to a host computer for transmitting a real-time data generated by the real-time signal processing apparatus to the host computer. It is also required by the host computer to transmit the real-time data back to the real-time signal processing apparatus. However, in some cases, the host computer may be a computer which is only capable for nonreal-time data transmission. For example, a host computer running the operating system such as Microsoft Windows may be used by the radar system to run its self test. When the host computer is a nonreal-time transmission system, the error such as data transmission overtime or data is not transmitted in right order, may be occurred in the real-time signal processing apparatus operation, which causes the real-time signal processing apparatus cannot normally operate.

### SUMMARY OF INVENTION

In the light of the preface, it is an object of the present invention to provide a real-time data transmission interface for transmitting the nonreal-time data in real-time and transmitting the real-time data in nonreal-time.

It is another object of the present invention to provide a real-time data transmission system. The system connects a nonreal-time transmission host computer to a real-time signal processing apparatus, on which the data is transmitted without any error.

The object of the present invention is to provide a real-time data transmission interface. The interface is suitable for transmitting the nonreal-time data in real-time and transmitting the real-time data in nonreal-time. The real-time data transmission interface provided by the present invention comprises a nonreal-time data interface unit for receiving/transmitting the nonreal-time data, and an I/O unit which is coupled to the nonreal-time data interface unit. Wherein, the I/O unit is used as an interface for transmitting the nonreal-time data and the real-time data. In addition, the present invention further comprises a memory unit and a network interface control unit. The memory unit is coupled to the I/O unit for storing the nonreal-time data and the real-time data. The network interface control unit is coupled to the memory unit for receiving/transmitting the real-time data.

In an embodiment of the present invention, the nonreal-time data interface unit comprises a bus interface unit, which is used as an interface for inputting/outputting the nonreal-time data. In addition, the nonreal-time data interface unit further comprises a data output latch, a data input latch, a control signal latch, which are all jointly coupled to the bus interface unit via an internal data bus. Moreover, the nonreal-time data interface unit further comprises a buffer and a flag register. Wherein, the buffer is coupled to the bus interface unit via the internal data bus. The flag register is coupled to the buffer for storing a flag state. Preferably, the nonreal-time data interface unit further comprises a clock generator for generating a clock signal and providing the clock signal to other units, wherein the frequency of the clock signal is 10 MHz.

In addition, the I/O unit comprises a control logic unit, which instructs the I/O unit to perform a read/write operation according to an external control signal. The I/O unit further comprises a checking circuit, a data output latch, and a data input latch, which are all jointly coupled to the control logic unit. Wherein, when a self test mode is activated, the control logic unit controls the checking circuit to check the accuracy of the data output by the I/O unit and to generate a checking result.

In addition, the memory unit comprises a control logic unit, which controls the memory unit operation according to the external control signal. Moreover, the memory unit further comprises a first address counter, a first memory, and a first buffer latch unit. Wherein, the first address counter is coupled to the control logic unit for providing a first address to the first memory. The first memory is used to store the nonreal-time data, and the first memory is coupled to the first buffer latch unit via the internal data bus. In the embodiment of the present invention, the memory unit further comprises a second address counter, a second memory, and a second buffer latch unit, which are deployed, correspondingly.

Preferably, the network interface control unit comprises a programmable interface controller and a TTL/differential level converting interface. Wherein, the TTL/differential level converting interface is used to convert the type of the real-time data from TTL to differential or in reverse, and to cache the real-time data. In addition, the programmable interface controller comprises a storage apparatus and a sequencer. Wherein, the storage apparatus stores a microcode internally, and the microcode is used to control the operation of the programmable interface controller. The sequencer is coupled to the storage apparatus for running the microcode instructions and adjusting the running order based on an external condition. The programmable interface controller further comprises a condition selector and an event/interrupt handler. Wherein, the condition selector is coupled to the sequencer for caching the external condition, and the external condition is then provided to the sequencer for it to make decision. The event/interrupt handler is coupled to the storage apparatus for processing an interrupt signal or handling an event. In addition, the programmable interface controller further comprises a processor and a parity bit generating/checking apparatus. Wherein, the processor is coupled to the storage apparatus for running the microcode instructions. The parity bit generating/checking apparatus generates a parity bit according to the real-time data provided by the programmable interface controller, and checks the parity bit of the real-time data provided by the programmable interface controller.

According to another aspect of the present invention, the present invention provides a real-time data transmission system. The system comprises a nonreal-time processing host computer, a real-time signal processing apparatus, and a data transmission circuit. Wherein, the data transmission circuit connects the real-time signal processing apparatus to the host computer, so that the real-time signal processing apparatus can receive the nonreal-time data transmitted from the host computer, and the host computer can transmit the nonreal-time data to the real-time signal processing apparatus in a way of simulating the real-time transmission. Moreover, the data transmission circuit is also used by the host computer to receive the real-time data transmitted from the real-time signal processing apparatus and used by the real-time data processing apparatus to transmit the real-time data to the host computer in a way of simulating the real-time transmission.

In summary, when it is required to transmit the nonreal-time data in real time, the present invention first caches the nonreal-time data in the memory unit, and then transmits it in nonreal-time later. The same idea can be also applied in transmitting the real-time data in nonreal-time. In addition, an address counter is included in the memory unit of the present invention, thus the transmission sequence error problem should not happen in data transmission any more. Therefore, the present invention can effectively reduce the errors occurred in data transmission.

### BRIEF DESCRIPTION OF DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 is a schematic block diagram illustrating a real-time data transmission system according to a preferred embodiment of the present invention.

FIG. 2 is a schematic internal block diagram illustrating a real-time data transmission circuit according to a preferred embodiment of the present invention.

FIG. 3 is a schematic block diagram illustrating the internal configuration of a nonreal-time data interface unit according to a preferred embodiment of the present invention.

FIG. 4 is a schematic block diagram illustrating the internal configuration of an I/O unit according to a preferred embodiment of the present invention.

FIG. 5 is a schematic block diagram illustrating the internal configuration of a memory unit according to a preferred embodiment of the present invention.

FIG. 6 is a schematic block diagram illustrating the internal configuration of a programmable interface controller according to a preferred embodiment of the present invention.

### DETAILED DESCRIPTION

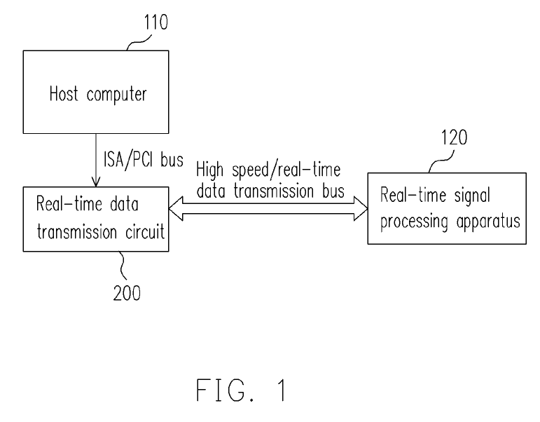

FIG. 1 is a schematic block diagram illustrating a real-time data transmission system according to a preferred embodiment of the present invention. Referring to FIG. 1, the data transmission circuit 200 provided by the present invention for connecting the host computer 110 and the real-time signal processing apparatus 120 works as a real-time data transmission interface. Wherein, the host computer 110 is operated based on a nonreal-time processing operating system, such as Microsoft Windows operating system. The real-time signal processing apparatus 120, e.g. a radar system, is used to process the real-time signal.

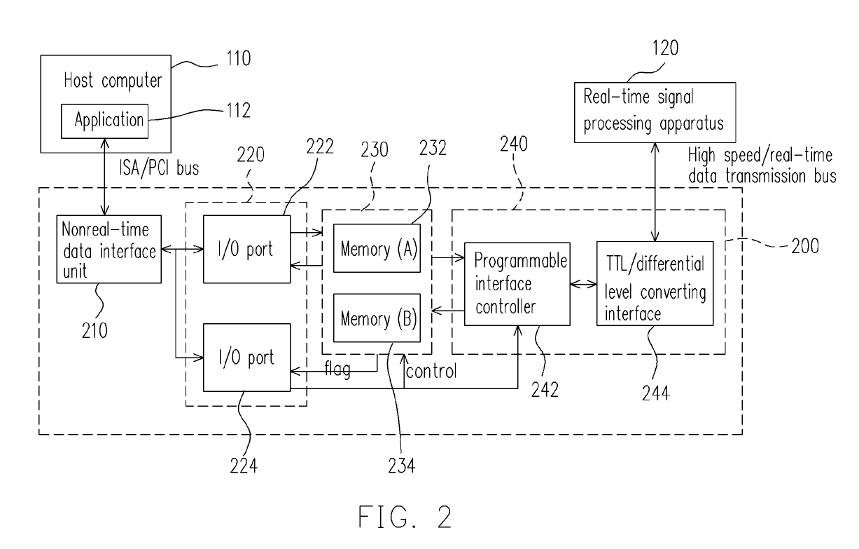

FIG. 2 is a schematic internal block diagram illustrating a real-time data transmission circuit according to a preferred embodiment of the present invention. Referring to FIG. 2, the real-time data transmission circuit 200 and the host computer 110 transmit the nonreal-time data with each other by using an ISA/PCI bus, for example. In addition, a high speed/real-time data transmission bus, e.g. a military specification ANC bus, is used as a data transmission path between the real-time data transmission circuit 200 and the real-time signal processing apparatus 120 for transmitting data in real time. In the present embodiment, the host computer 110 is coupled to the nonreal-time data interface unit 210 of the data transmission circuit 200 via the ISA/PCI bus in order to provide the nonreal-time data to the data transmission circuit 200. After the nonreal-time data has passed through the I/O unit 220, the nonreal-time data is then stored in the memory unit 230. The real-time signal processing apparatus 120 reads the nonreal-time data stored in the memory unit 230 in real time via the network interface control unit 240. Oppositely, when the real-time signal processing apparatus 120 intends to transmit the real-time data to the host computer 110, the data is transmitted in reverse way.

To be more specifically, when an application 112 in the host computer 110 knows that the real-time signal processing apparatus 120 requests to transmit data in real time, the application 112 transmits the nonreal-time data as well as a control word “control” which is used to control the memory unit 230 and the network interface control unit 240 to the nonreal-time data interface unit 210 via the ISA/PCI, for example. Then, the nonreal-time data interface unit 210 transmits the nonreal-time data to an I/O port 222 of the I/O unit 220. In addition, the nonreal-time data interface unit 210 stores the control word “control” to an I/O port 224. Wherein, the I/O port 222 determines whether to write the nonreal-time data into a memory unit 230. If it is determined by the I/O port 222 that it is required to write the nonreal-time data into the memory unit 230, the nonreal-time data is written into the memory (A) 232.

Referring to FIG. 2 again, after the nonreal-time data has stored in a memory (A) 232, the network interface control unit 240 reads the nonreal-time data from the memory unit 230 in real time according to the control word “control”, and transmits the nonreal-time data to the real-time signal processing apparatus 120 via a high speed/real-time data transmission bus, e.g. an ANC bus. Oppositely, when the real-time signal processing apparatus 120 intends to transmit the real-time data to the host computer 110, the real-time data is stored into a memory (B) 234 via the network interface control unit 240. Afterwards, the I/O port 222 reads the real-time data from the memory unit 230, and transmits the real-time data to the host computer 110 in nonreal time via the nonreal-time data interface unit 210.

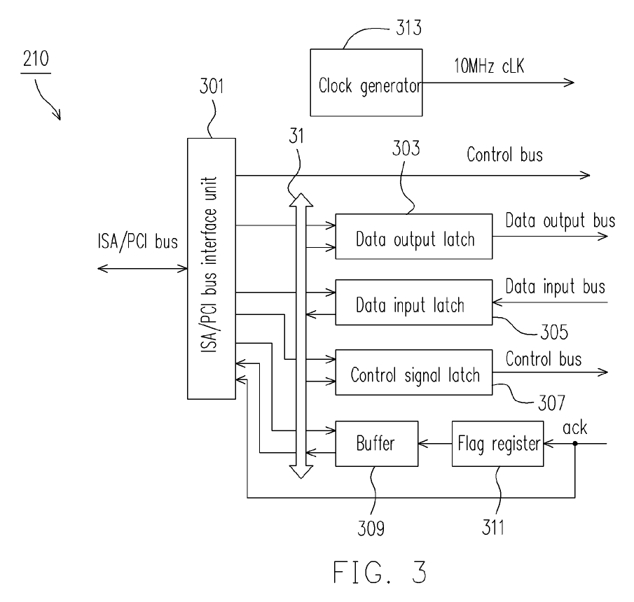

The internal configuration of each functional block is described in detail hereinafter, respectively. FIG. 3 is a schematic block diagram illustrating the internal configuration of a nonreal-time data interface unit according to a preferred embodiment of the present invention. As shown in the diagram, an ISA/PCI bus interface unit 301 receives the nonreal-time data transmitted by the ISA/PCI bus first, and then transmits the nonreal-time data to a data output latch 303 and a data input latch 305 via an internal data bus 31, respectively. When the nonreal-time data is provided to the nonreal-time data interface unit 210, the nonreal-time data is transmitted to the data output latch 303 via the ISA/PCI bus first, and then transmitted to outside via a data output bus. If it is intended to transmit an external real-time data to the ISA/PCI bus via the nonreal-time data interface unit 210, the external real-time data is transmitted to the data input latch 305 via an data input bus first, and then transmitted to the ISA/PCI bus interface unit 301 via the internal data bus, and finally transmitted to outside via the ISA/PCI bus.

Referring to FIG. 3 again, the ISA/PCI bus interface unit 301 controls the latch/buffer apparatus in other functional block of the present invention, so as to control data transmission direction. In addition, the internal control signal of the nonreal-time data interface unit 210 and the control signal of other functional block of the present invention are cached in a control signal latch 307 via the internal data bus 31. Then, the control signal for controlling other functional block of the present invention is propagated via a control bus. In addition, a buffer 309 in the nonreal-time data interface unit 210 is coupled to a flag register 311. In the present embodiment, the flag register 311 provides two flags for other functional blocks to setup its flag. An acknowledgement signal “ack” may be used by other functional block of the present invention to setup its flag, and the flag is used to indicate a current state of the functional block. For example, the host computer 110 shown in FIG. 1 can read or clear the flag state stored in the flag register 311 via the internal data bus 31. When the acknowledgement signal “ack” is enabled, and the host computer 110 has been notified via the ISA/PCI bus interface unit 301 of it, the host computer 110 will read or clear the flag state via the ISA/PCI bus interface unit 301.

The buffer 309 may be a 3-state (tri-state) buffer, and it is in an “ON” state when the host computer 110 is reading or clearing the flag. When the nonreal-time data interface unit 210 is transmitting data, the buffer 309 is in a high impedance state. In addition, a clock generator 313 may be further included in the nonreal-time data interface unit 210 for providing an operating clock which is required by the rest of the functional blocks of the present invention. In the present invention, the frequency of the clock signal generated by the clock generator 313 is 10 MHz.

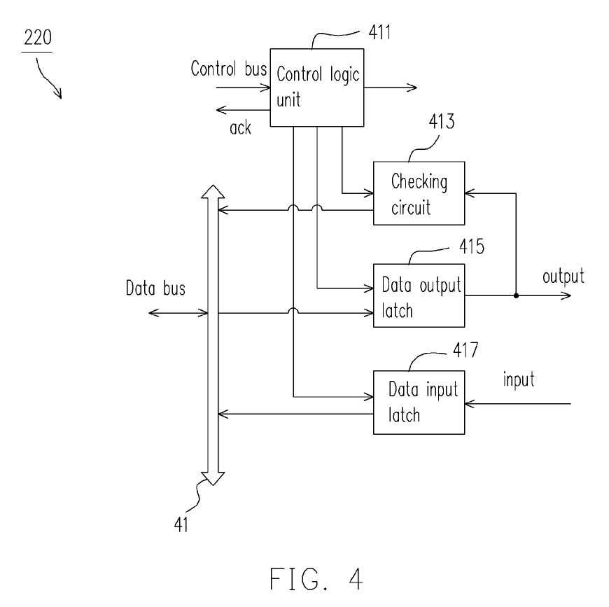

FIG. 4 is a schematic block diagram illustrating the internal configuration of an I/O unit according to a preferred embodiment of the present invention. Referring to FIG. 4, a logic control unit 411 generates and provides an internal control signal to a checking circuit 413, a data output latch 415, and a data input latch 417 according to a control signal which is generated by the nonreal-time data interface unit 210 and transmitted via the control bus. In addition, the logic control unit 411 provides an acknowledgement signal “ack”, which is used to indicate the current state of the I/O unit 220. When it is required to transmit the nonreal-time data through the I/O unit 220, the nonreal-time data is transmitted to a bi-directional bus 41 via the data bus first, and then the data output latch 415 extracts the nonreal-time data from the bi-directional bus 41, and determines whether to output the nonreal-time data via the data output bus or not according to the control of the control logic unit 411. Oppositely, when it is required to transmit the real-time data via the I/O unit 220, the real-time data is stored into the data input latch 417 via the data input bus first, and then it is determined whether to transmit the real-time data to the bi-directional bus 41 or not according to the control of the control logic unit 411.

Referring to FIG. 4 again, in the present embodiment, the I/O unit 220 further comprises a checking circuit 413. When the self test mode of the present invention is activated, the checking circuit 413 checks the data output from the I/O unit 220, and provides the checking result to the bi-directional bus 41.

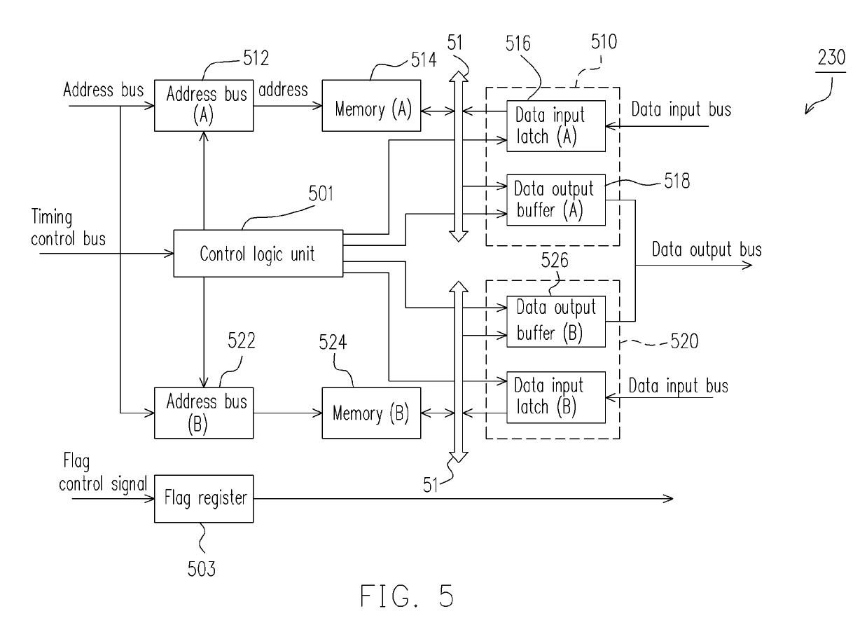

FIG. 5 is a schematic block diagram illustrating the internal configuration of a memory unit according to a preferred embodiment of the present invention. Referring to FIG. 5, the memory unit 530 comprises a control logic unit 501 and two sets of symmetric storage modules. Wherein, an address counter (A) 512, a memory (A) 514, and a buffer latch unit (A) 510 togetherly constitute a storage module (A). In addition, an address counter (B) 522, a memory (B) 524, and a buffer latch unit (B) 520 togetherly constitute a storage module (B). Since the operation mode of the storage modules (A) and (B) is rather the same, only the operation principle of the storage module (A) is described in detail hereinafter.

Referring to FIG. 5 again, the control logic unit 510 is coupled to the address counter (A) 512 and the address counter (B) 522, respectively. In addition, the control logic unit 510 is further coupled to the memory (A) 514 and the memory (B) 524, respectively. Moreover, the control logic unit 501 is coupled to the buffer latch unit (A) 510 and the buffer latch unit (B) 520 via the internal data bus. Wherein, the control logic unit 501 receives an external control signal transmitted by the control bus, so as to generate an internal control signal which is used to control the memory unit 530. The address counter (A) 512 receives an address signal transmitted by the address bus, so as to generate and transmit an address of “address” to the memory (A) 514. The address of the memory (A) 514, i.e. “address”, may be either loaded by the host computer 110 shown in FIG. 2 or sequentially generated by the address counter (A) 512. The memory (A) 514 is coupled to the buffer latch unit (A) 510 via the internal data bus 51, wherein the buffer latch unit (A) 510 comprises a data input latch (A) 516 and a data output buffer (A) 518. The operating principle and function of the buffer latch unit (A) 510 is similar to the one shown in FIGS. 3 and 4, thus its detail description is neglected herein.

In the present embodiment, the two sets of the storage modules are working independently, thus the two sets of the storage modules can be in the writing state at the same time. However, since the data output buffer (A) 518 and the data output buffer (B) 528 are sharing a same data output bus, only one storage module is allowed to be in the output state at the same time.

In addition, the memory unit 230 in the present embodiment further comprises a flag register 503 for providing two flags, which are used by the host computer 110 to configure or clear its value, and the host computer 110 can read the flag state from the flag register 503.

Referring to FIG. 2 again, the network interface control unit 240 comprises a programmable interface controller 242 and a TTL/differential level converting interface 244. Wherein, the programmable interface controller 242 is responsible for controlling the real-time data transmission of the real-time transmission circuit 200 and the real-time signal processing apparatus 120. The TTL/differential level converting interface 244 is working on a high speed/real-time data transmission bus signal for converting its type from TTL to differential, such that the interference caused by the noise can be avoided.

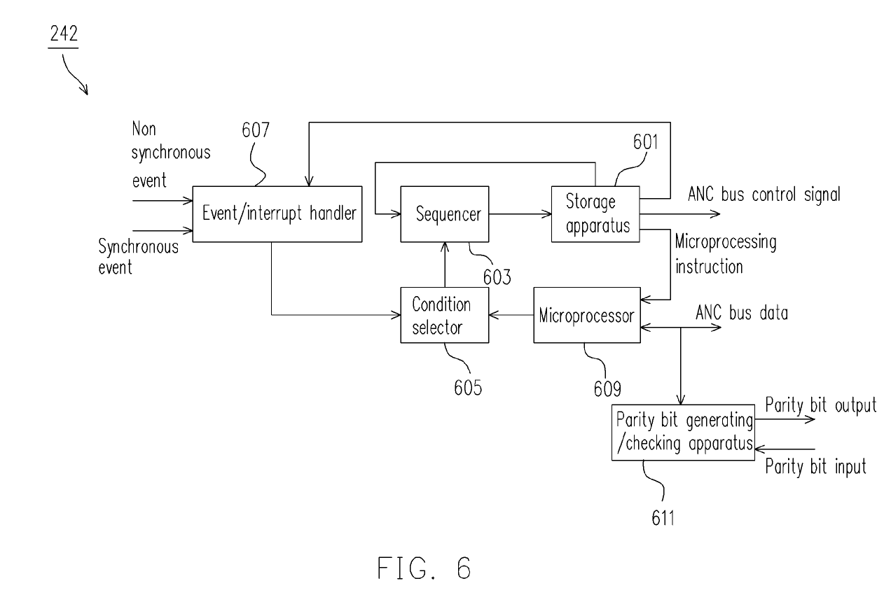

FIG. 6 is a schematic block diagram illustrating the internal configuration of a programmable interface controller according to a preferred embodiment of the present invention. Referring to FIG. 6, a microcode is burned into a storage apparatus 601 internally, wherein the microcode is used to control the operation flow of the network interface control unit 240. A sequencer 603 is coupled to the storage apparatus 601 for running the microcode which is burned into the storage apparatus 601. In addition, the sequencer 603 can adjust the running order of the microcode based on an external condition. In the present embodiment, the external condition is generated by a condition selector which is coupled to the sequencer 603. Moreover, the storage apparatus 601 is further coupled to an event/interrupt handler 607 and a microprocessor 609. Wherein, the event/interrupt handler 607 is used to disable, enable, or handle the interrupt signal or event generated by the host computer of FIG. 2, and the event/interrupt handle 607 can generate and provide an interrupt vector to a condition selector 605, such that the sequencer 603 can run an interrupt service routine.

The microprocessor 609 is used to run the arithmetic logic unit operations, wherein the operations are instructed by the sequencer 603 for generating a result. In addition, in the present embodiment, the programmable interface controller 242 further comprises a parity bit generating/checking apparatus 611, which is used to check the accuracy of the data parity bit in the programmable interface controller 242, and to generate and provide the parity bit to the data which is output from the programmable interface controller 242.

In summary, since a parity bit checking/generating apparatus is deployed in the real-time data transmission system of the present invention, the amount of the data transmission error is significantly decreased. In addition, since an address counter is deployed in the memory unit of the present invention, the data sequence error happened in data transmission is also totally eliminated. Furthermore, the real-time data transmission interface provided by the present invention stores the nonreal-time data or real-time data in the memory unit during the data transmission. Therefore, it is possible to transmit the nonreal-time data in real time and transmit the real-time data in nonreal-time.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

1. A real-time data transmission interface suitable for transmitting a nonreal-time data in real-time and transmitting a real-time data in nonreal-time, and the real-time data transmission interface comprising:
a nonreal-time data interface unit for receiving/transmitting the nonreal-time data;
an I/O unit coupled to the nonreal-time data interface unit and being used as a transmission interface for the nonreal-time data and the real-time data;
a memory unit coupled to the I/O unit for caching the nonreal-time data and the real-time data; and
a network interface control unit coupled to the memory unit for receiving/transmitting the real-time data.

2. The real-time data transmission interface of claim 1, wherein the nonreal-time data interface unit comprises:
a bus interface unit working as an interface for inputting/outputting the nonreal-time data;
a data output latch coupled to the bus interface unit via an internal data bus, wherein the data output latch is a latch for latching a data transmitted by the nonreal-time data interface unit to other units;
a data input latch coupled to the bus interface unit via the internal data bus, wherein the data input latch is a latch for latching a data transmitted by the other unit and received by the nonreal-time data interface unit;
a control signal latch coupled to the bus interface unit via the internal data bus, wherein the data output latch is a latch for latching a control signal transmitted by the nonreal-time data interface unit to other units;
a buffer coupled to the bus interface unit via the internal data bus; and
a flag register coupled to the buffer for storing a flag state.

3. The real-time data transmission interface of claim 2, wherein the buffer comprises a 3-state (tri-state) buffer, when the flag state in the flag register is being setting/reading, the 3-state buffer is in an “on” state, while when the flag state is not being setting/reading, and the 3-state buffer is in a high impedance state.

4. The real-time data transmission interface of claim 2, wherein the nonreal-time data interface unit further comprises a clock generator for generating and providing a clock signal to other units, and a frequency of the clock signal is 10 MHz.

5. The real-time data transmission interface of claim 1, wherein the I/O unit comprises:
a control logic unit for controlling the I/O unit to perform a read/write operation according to an external control signal;
a checking circuit coupled to the control logic unit, wherein when a self test mode is activated, the control logic unit controls the checking circuit to check an accuracy of the data output from the I/O unit and to generate a checking result;
a data output latch coupled to the control logic unit, wherein when the nonreal-time data is transmitted via the I/O unit, the control logic unit controls the data output latch to latch the nonreal-time data, and determines whether to output the nonreal-time data; and
a data input latch coupled to the control logic unit, wherein when the real-time data is read via the I/O unit, the data input latch receives the real-time data.

6. The real-time data transmission interface of claim 1, wherein the memory unit comprises:
a control logic unit for controlling the memory unit according to an external control signal;
a first address counter coupled to the control logic unit for providing a first address;
a first memory coupled to the first address counter for storing the nonreal-time data;
a first buffer latch unit coupled to the first memory via an internal data bus for working as an input/output interface of the first memory;
a second address counter coupled to the control logic unit for providing a second address;
a second memory coupled to the second address counter for storing the real-time data; and
a second buffer latch unit coupled to the second memory via the internal data bus for working as an input/output interface of the second memory.

7. The real-time data transmission interface of claim 6, wherein the memory unit further comprises a flag register for storing a flag state.

8. The real-time data transmission interface of claim 1, wherein the network interface control unit comprises a programmable interface controller and a TTL/differential level converting interface, wherein the TTL/differential level converting interface is used to convert a type of the real-time data from TTL to differential or in reverse, and to cache the real-time data.

9. The real-time data transmission interface of claim 8, wherein the programmable interface controller comprises:
a storage apparatus, wherein a microcode is stored in the storage apparatus for controlling an operation of the programmable interface controller;
a sequencer coupled to the storage apparatus for running a microcode instruction and for adjusting a running order according to an external condition;
a condition selector coupled to the sequencer for caching the external condition, which is used by the sequencer for its determining;
an event/interrupt handler coupled to the storage apparatus for handling either an interrupt signal or an event;
a processor coupled to the storage apparatus for running the microcode instruction; and
a parity generating/checking apparatus for either generating a parity bit according to the real-time data output from the programmable interface counter or checking the parity bit of the real-time data input into the programmable interface controller.

10. A real-time data transmission system, comprising:
a host computer, wherein the host computer is operated based on a nonreal-time processing operating system;
a real-time signal processing apparatus for processing a real-time data; and
a data transmission circuit for connecting the host computer and the real-time signal processing apparatus, wherein the data transmission circuit receives a nonreal-time data transmitted from the host computer, and transmits the nonreal-time data to the real-time signal processing apparatus in a way of simulating a real-time transmission, in addition, the data transmission circuit receives the real-time data transmitted from the real-time signal processing apparatus, and transmits the real-time data to the host computer in a way of simulating a nonreal-time transmission.

11. The real-time data transmission system of claim 10, wherein the host computer has an application which is used to control an operation of the data transmission circuit.

12. The real-time data transmission system of claim 10, wherein the data transmission circuit comprises:
a nonreal-time data interface unit coupled to the host computer, wherein the nonreal-time data interface unit is used as a data transmission interface between the host computer and the data transmission circuit, and the nonreal-time data interface unit provides a clock signal;
an I/O unit coupled to the nonreal-time data interface unit, wherein the I/O unit is used to latch the nonreal-time data on a data output bus, and to latch the real-time data on a data input bus;
a memory unit coupled to the I/O unit for storing the nonreal-time data and the real-time data; and
a network interface control unit coupled to the memory unit and the real-time signal processing apparatus, wherein the network interface control unit is used as a data transmission interface between the real-time signal processing apparatus and the data transmission circuit.

13. The real-time data transmission system of claim 12, wherein the data is transmitted between the nonreal-time data interface unit and the host computer based on an ISA/PCI bus.

14. The real-time data transmission system of claim 12, wherein the I/O unit comprises a first I/O port and a second I/O port, and the first I/O port stores a control word which is used to control the network interface control unit and transmits back a flag state to the host computer, in addition, the second I/O port writes the nonreal-time data to the network interface control unit or reads the real-time data from the network interface control unit.

15. The real-time data transmission system of claim 12, wherein the memory unit comprises a first memory and a second memory for storing the real-time data and the nonreal-time data.

16. The real-time data transmission system of claim 12, wherein the network interface control unit comprises a programmable interface controller and a TTL/differential level converting interface.

17. The real-time data transmission system of claim 16, wherein the programmable interface controller is used to transmit data with the real-time signal processing apparatus in real-time.

18. The real-time data transmission system of claim 16, wherein the TTL/differential level converting interface is used to convert a TTL type bus signal into a differential type bus signal.
